(19) United States
(12) Patent Application Publication
(10) Pub. No.: US 2010/0287783 A1
(43) Pub. Date: Nov. 18, 2010

(54) Container Opener Apparatus

(76) Inventor: Garrett Frink, Weare, NH (US)

Correspondence Address: HAYES, SOLOWAY P.C., 175 CANAL STREET, MANCHESTER, NH, 03101, US

(21) Appl. No.: 12/782,176

(22) Filed: May 18, 2010

Related U.S. Application Data
(60) Provisional application No. 61/179,102, filed on May 18, 2009.

(51) Int. Cl. B67B 7/00

(52) U.S. Cl. 30/400

(57) ABSTRACT

A method and apparatus for opening a container is provided. A container opener includes a handle portion and a container guide affixed to the handle portion. At least one puncturing structure is affixed to the container guide. The at least one puncturing structure may be positioned to puncture a seal affixed to a wall of the container.

### CROSS REFERENCE TO RELATED APPLICATION

This application claims benefit of U.S. Provisional Application Ser. No. 61/179,102 filed May 18, 2009, the entire disclosure of which is incorporated herein by reference.

### FIELD OF THE DISCLOSURE

The present disclosure is generally related to opening containers and more particularly is related to opening containers having a puncturable seal between a lid and container wall.

### BACKGROUND OF THE DISCLOSURE

Containers are used to house many products, such as food products, tobacco products, chemicals and other products requiring a container for storage and/or transportation. Many of these containers require a seal placed proximate to the lid and the wall of the container to keep the lid affixed during transportation. Additionally, a seal may be used to keep air and other substances from penetrating the container and negatively affecting the product housed inside. To open containers of this variety, the seal may need to be punctured, torn or otherwise removed, and may require the use of a device that assists with convenient and efficient breaking of the seal to allow a user to access the contents within the container.

### SUMMARY OF THE DISCLOSURE

Embodiments of the present disclosure provide an apparatus for opening a container. Briefly described, in architecture, one embodiment of the apparatus, among others, can be implemented as follows. A container opener includes a handle portion. A container guide is affixed to the handle portion. At least one puncturing structure is affixed to the container guide.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a top-view illustration of a container opener, in accordance with a first exemplary embodiment of the present disclosure.

FIG. 2 is a bottom-view illustration of a container opener, in accordance with the first exemplary embodiment of the present disclosure.

FIG. 3 is a side-view illustration of a container opener, in accordance with the first exemplary embodiment of the present disclosure.

FIG. 4 is a top-view illustration of a container opener, in accordance with a second exemplary embodiment of the present disclosure.

FIG. 5 is a bottom-view illustration of a container opener, in accordance with the second exemplary embodiment of the present disclosure.

FIG. 6 is a side-view illustration of a container opener, in accordance with the second exemplary embodiment of the present disclosure.

FIG. 7 is a top-view illustration of a container opener, in accordance with a third exemplary embodiment of the present disclosure.

FIG. 8 is a bottom-view illustration of a container opener, in accordance with the third exemplary embodiment of the present disclosure.

FIG. 9 is a side-view illustration of a container opener, in accordance with the third exemplary embodiment of the present disclosure.

FIG. 10 is a top-view illustration of a container opener, in accordance with a fourth exemplary embodiment of the present disclosure.

FIG. 11 is a bottom-view illustration of a container opener, in accordance with the fourth exemplary embodiment of the present disclosure.

FIG. 12 is a side-view illustration of a container opener, in accordance with the fourth exemplary embodiment of the present disclosure.

FIG. 13 is a top-view illustration of a container opener, in accordance with a fifth exemplary embodiment of the present disclosure.

FIG. 14 is a bottom-view illustration of a container opener, in accordance with the fifth exemplary embodiment of the present disclosure.

FIG. 15 is a side-view illustration of a container opener, in accordance with the fifth exemplary embodiment of the present disclosure.

FIG. 16 is a top-view illustration of a container opener, in accordance with a sixth exemplary embodiment of the present disclosure.

FIG. 17 is a bottom-view illustration of a container opener, in accordance with the sixth exemplary embodiment of the present disclosure.

FIG. 18 is a side-view illustration of a container opener, in accordance with the sixth exemplary embodiment of the present disclosure.

FIG. 19 is a top-view illustration of a container opener, in accordance with a seventh exemplary embodiment of the present disclosure.

FIG. 20 is a bottom-view illustration of a container opener, in accordance with the seventh exemplary embodiment of the present disclosure.

FIG. 21 is a side-view illustration of a container opener, in accordance with the seventh exemplary embodiment of the present disclosure.

### DETAILED DESCRIPTION

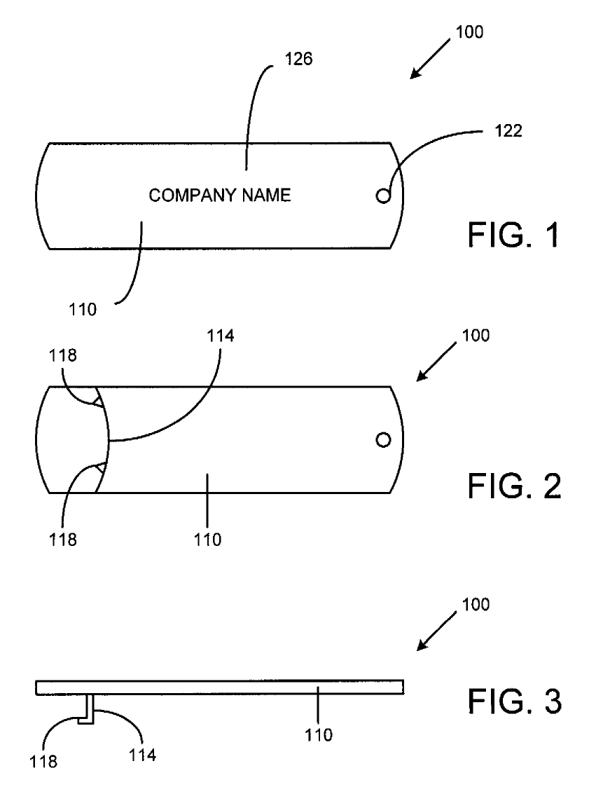

FIGS. 1, 2 and 3 are top-view, bottom-view and side-view illustrations, respectively, of a container opener 100 in accordance with a first exemplary embodiment of the present disclosure. The container opener 100 includes a handle portion 110, a container guide 114 and at least one puncturing structure 118. The handle portion 110 may include any structure, such as a planar structure having at least two substantially planar sides and a convenient ergonomic design. Additionally, the handle portion 110 may include any shape, such as the general shape of a rectangular with opposing arced ends, as depicted in FIGS. 1 and 2. The container guide 114 may be affixed to the handle portion 110 in a variety of configurations. In the first exemplary embodiment, the container guide 114 is affixed to one of the planar sides and protrudes away from the planar surface of the handle portion 110. The container guide 114 may include any shape, such as a curved or arced shape, as depicted in FIG. 2. The at least one puncturing structure 118 may be affixed to one or more sides of the container guide 114.

The container opener 100 also may include an attachment hole 122 for attaching a key ring or other structure to the container opener 100, and/or an identifying mark 126 to identify a characteristic or origin of the container opener 100. The identifying mark 126 may include any means of identifying the container opener 100, including an inscribed, printed, embedded or otherwise affixed word, logo, design, texture or picture. In FIG. 1, the identifying mark 126 is located on a planar surface of the container opener 100, but it may be located on any other part of the container opener 100 as well.

The container opener 100, and any combination of the parts thereof, may be constructed from a variety of materials, including plastics, metals ceramics and composite or organic materials. For example, the container opener 100 may include a handle portion 110 and container guide 114 that are constructed from extruded plastic and an at least one puncturing structure 118 constructed from a metallic composition. Additionally, the container opener 100 may be constructed with a variety of adhesives materials or manufacturing techniques, all of which are considered within the scope of the present disclosure. The container opener 100 may also include other materials, such as paint or reflective coatings, or other devices, such as small LED lights or bottle openers.

The container opener 100 may be used with a variety of containers, having a variety of shapes and sizes. In accordance with the first exemplary embodiment, the container may be cylindrical in shape and have a lid that is affixed to one of the two opposing ends of the container. The lid may be affixed to the container wall with a puncturable seal, such as adhesive paper or tape. In use, the container opener 100 may be placed proximate to the container, such that the handle portion 110 abuts the lid of the container, and the container guide 114 abuts a portion of the cylindrical wall of the container. The container opener 100 may be biased towards the center of the container to a position where the at least one puncturing structure 118 punctures a seal. As the seal is punctured, the at least one puncturing structure 118 will be located in a position proximate to the lid and container wall. The container opener 100 may then be rotated about the center of the container to separate the lid from the container wall by cutting the seal. After the container opener 100 has been rotated a substantial amount (approx. 270° or more), any remaining seal that is still affixed may be torn apart to fully release the lid from the container wall. A user may then have full access to the inside of the container and any contents thereof.

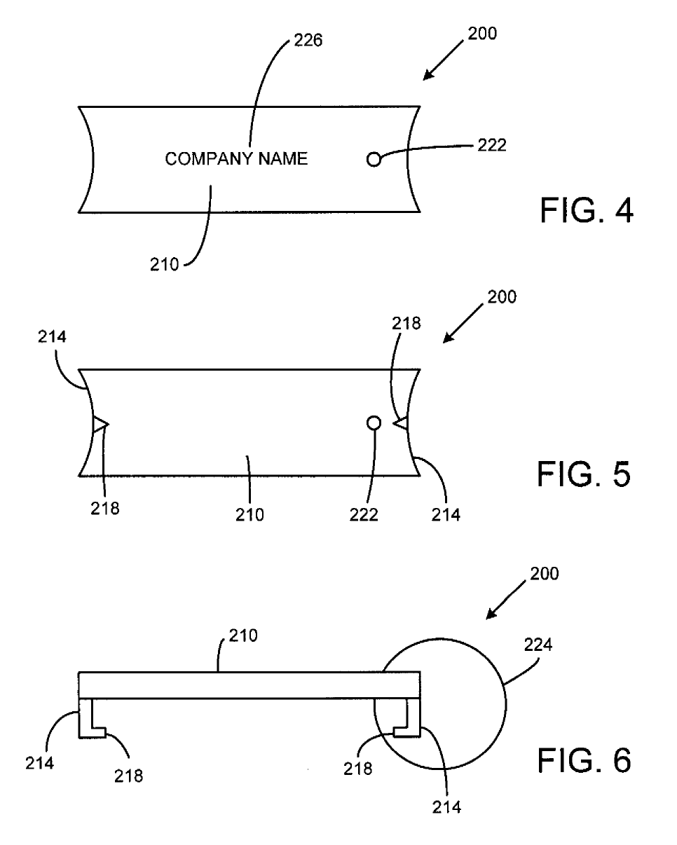

FIGS. 4, 5 and 6 are top-view, bottom-view and side-view illustrations, respectively, of a container opener 200 in accordance with a second exemplary embodiment of the present disclosure. The container opener 200 includes a handle portion 210, a container guide 214 and at least one puncturing structure 218. The handle portion 210 may include any structure, such as a planar structure having at least two substantially planar sides and a convenient ergonomic design. Additionally, the handle portion 210 may include any shape, such as the general shape of a rectangular with opposing arced ends, as depicted in FIGS. 4 and 5. The container guide 214 may be affixed to the handle portion 210 in a variety of configurations. In the second exemplary embodiment, two container guides 214 are depicted on opposing ends of the handle portion 210, and are affixed to one of the planar sides and protruding away from the planar surface of the handle portion 210. The container guide 214 may include any shape, such as a curved or arced shape, as depicted in FIG. 5. The at least one puncturing structure 218 may be affixed to one or more sides of the container guide 214. In the second exemplary embodiment, one puncturing structure 218 is affixed to each container guide 218.

The container opener 200 also may include an attachment hole 222 for attaching a key ring 224 or other structure to the container opener 200, and/or an identifying mark 226 to identify a characteristic or origin of the container opener 200. The identifying mark 226 may include any means of identifying the container opener 200, including an inscribed, printed, embedded or otherwise affixed word, logo, design, texture or picture. In FIG. 4, the identifying mark 226 is located on a planar surface of the container opener 200, but it may be located on any other part of the container opener 200 as well.

The container opener 200, and any combination of the parts thereof, may be constructed from a variety of materials, including plastics, metals ceramics and composite or organic materials. For example, the container opener 200 may include a handle portion 210 and container guide 214 that are constructed from extruded plastic and an at least one puncturing structure 218 constructed from a metallic composition. Additionally, the container opener 200 may be constructed with a variety of adhesives materials or manufacturing techniques, all of which are considered within the scope of the present disclosure. The container opener 200 may also include other materials, such as paint or reflective coatings, or other devices, such as small LED lights or bottle openers.

The container opener 200 may be used with a variety of containers, having a variety of shapes and sizes. In accordance with the second exemplary embodiment, the container may be cylindrical in shape and have a lid that is affixed to one of the two opposing ends of the container. The lid may be affixed to the container wall with a puncturable seal, such as adhesive paper or tape. In use, the container opener 200 may be placed proximate to the container, such that the handle portion 210 abuts the lid of the container, and each of the container guides 214 abut opposing portions of the cylindrical wall of the container. The container opener 200 may be biased towards the center of the container to a position where the at least one puncturing structure 218 punctures a seal. As the seal is punctured, the at least one puncturing structure 218 will be located in a position proximate to the lid and container wall. The container opener 200 may then be rotated about the center of the container to separate the lid from the container wall by cutting the seal. After the container opener 200 has been rotated a substantial amount (approx. 270° or more), any remaining seal that is still affixed may be torn apart to fully release the lid from the container wall. A user may then have full access to the inside of the container and any contents thereof.

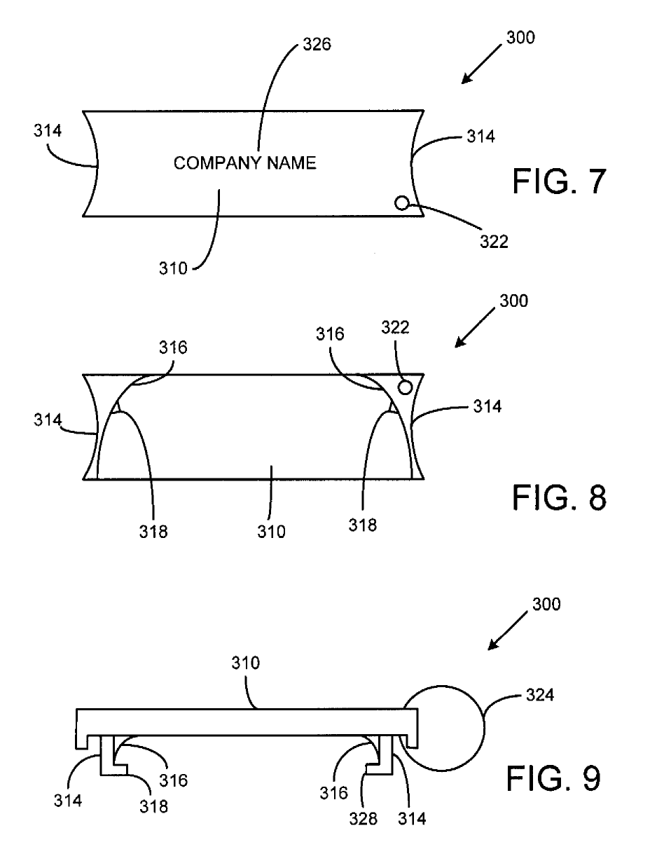

FIGS. 7, 8 and 9 are top-view, bottom-view and side-view illustrations, respectively, of a container opener 300 in accordance with a third exemplary embodiment of the present disclosure. The container opener 300 includes a handle portion 310, a container guide 314 and at least one puncturing structure 318. The handle portion 310 may include any structure, such as a planar structure having at least two substantially planar sides and a convenient ergonomic design. Additionally, the handle portion 310 may include any shape, such as the general shape of a rectangular with opposing arced ends, as depicted in FIGS. 7 and 8. The container guide 314 may be affixed to the handle portion 310 in a variety of configurations. In the third exemplary embodiment, two container guides 314 are depicted on opposing ends of the handle portion 310, and are affixed to one of the planar sides and protruding away from the planar surface of the handle portion 310. The container guide 314 may include any shape, such as a curved or arced shape, as depicted in FIG. 8. The third exemplary embodiment also contains a container guide 314 with an angled guiding surface 316 to assist with guiding the container opener 300 about the circumference of a container. The at least one puncturing structure 318 may be affixed to one or more sides of the container guide 314. In the third exemplary embodiment, one puncturing structure 318 is affixed to each container guide 314.

The container opener 300 also may include an attachment hole 322 for attaching a key ring 324 or other structure to the container opener 300, and/or an identifying mark 326 to identify a characteristic or origin of the container opener 300. The identifying mark 326 may include any means of identifying the container opener 300, including an inscribed, printed, embedded or otherwise affixed word, logo, design, texture or picture. In FIG. 7, the identifying mark 326 is located on a planar surface of the container opener 300, but it may be located on any other part of the container opener 300 as well.

The container opener 300, and any combination of the parts thereof, may be constructed from a variety of materials, including plastics, metals ceramics and composite or organic materials. For example, the container opener 300 may include a handle portion 310 and container guide 314 that are constructed from extruded plastic and an at least one puncturing structure 318 constructed from a metallic composition. Additionally, the container opener 300 may be constructed with a variety of adhesives materials or manufacturing techniques, all of which are considered within the scope of the present disclosure. The container opener 300 may also include other materials, such as paint or reflective coatings, or other devices, such as small LED lights or bottle openers.

The container opener 300 may be used with a variety of containers, having a variety of shapes and sizes. In accordance with the third exemplary embodiment, the container may be cylindrical in shape and have a lid that is affixed to one of the two opposing ends of the container. The lid may be affixed to the container wall with a puncturable seal, such as adhesive paper or tape. In use, the container opener 300 may be placed proximate to the container, such that the handle portion 310 abuts the lid of the container, and each of the container guides 314 abut opposing portions of the cylindrical wall of the container. The container opener 300 may be biased towards the center of the container to a position where the at least one puncturing structure 318 punctures a seal. As the seal is punctured, the at least one puncturing structure 318 will be located in a position proximate to the lid and container wall. The container opener 300 may be located in a position offset from the center of the container, with the angled guiding surface 316 abutting the container wall. The container opener 300 may then be rotated about the center of the container to separate the lid from the container wall by cutting the seal. After the container opener 300 has been rotated a substantial amount (approx. 270° or more), any remaining seal that is still affixed may be torn apart to fully release the lid from the container wall. A user may then have full access to the inside of the container and any contents thereof.

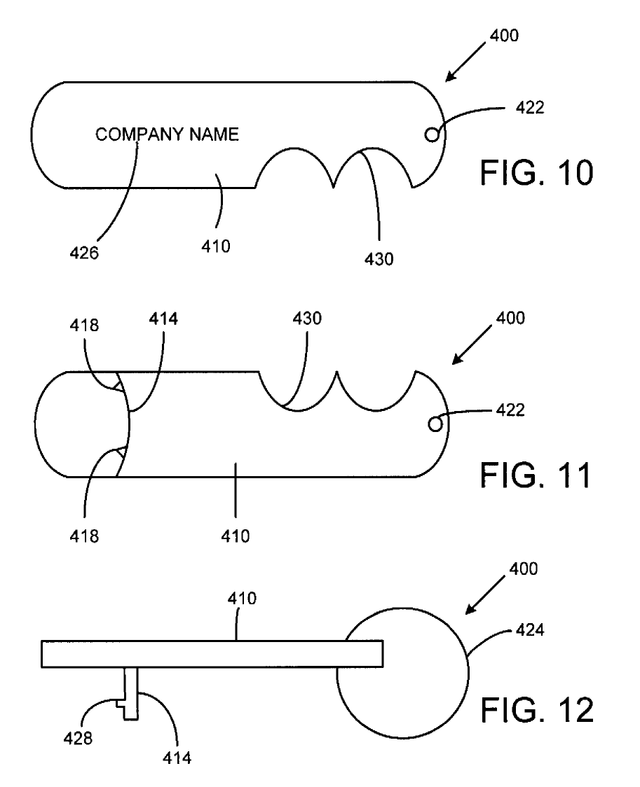

FIGS. 10, 11 and 12 are top-view, bottom-view and side-view illustrations, respectively, of a container opener 400 in accordance with a fourth exemplary embodiment of the present disclosure. The container opener 400 includes a handle portion 410, a container guide 414 and at least one puncturing structure 418. The handle portion 410 may include any structure, such as a planar structure having at least two substantially planar sides and a convenient ergonomic design. Additionally, the handle portion 410 may include any shape, such as the general shape of a rectangular with opposing arced ends, as depicted in FIGS. 10 and 11. The handle portion 410 may also include cutout portions 430 to enhance the ergonomic design of the container opener 400. The container guide 414 may be affixed to the handle portion 410 in a variety of configurations. In the fourth exemplary embodiment, the container guide 414 is affixed to one of the planar sides and protrudes away from the planar surface of the handle portion 410. The container guide 414 may include any shape, such as a curved or arced shape, as depicted in FIG. 11. The at least one puncturing structure 418 may be affixed to one or more sides of the container guide 414.

The container opener 400 also may include an attachment hole 422 for attaching a key ring 424 or other structure to the container opener 400, and/or an identifying mark 426 to identify a characteristic or origin of the container opener 400. The identifying mark 426 may include any means of identifying the container opener 400, including an inscribed, printed, embedded or otherwise affixed word, logo, design, texture or picture. In FIG. 10, the identifying mark 426 is located on a planar surface of the container opener 400, but it may be located on any other part of the container opener 400 as well.

The container opener 400, and any combination of the parts thereof, may be constructed from a variety of materials, including plastics, metals ceramics and composite or organic materials. For example, the container opener 400 may include a handle portion 410 and container guide 414 that are constructed from extruded plastic and an at least one puncturing structure 418 constructed from a metallic composition. Additionally, the container opener 400 may be constructed with a variety of adhesives materials or manufacturing techniques, all of which are considered within the scope of the present disclosure. The container opener 400 may also include other materials, such as paint or reflective coatings, or other devices, such as small LED lights or bottle openers.

The container opener 400 may be used with a variety of containers, having a variety of shapes and sizes. In accordance with the fourth exemplary embodiment, the container may be cylindrical in shape and have a lid that is affixed to one of the two opposing ends of the container. The lid may be affixed to the container wall with a puncturable seal, such as adhesive paper or tape. In use, the container opener 400 may be placed proximate to the container, such that the handle portion 410 abuts the lid of the container, and the container guide 414 abuts a portion of the cylindrical wall of the container. The container opener 400 may be biased towards the center of the container to a position where the at least one puncturing structure 418 punctures a seal. As the seal is punctured, the at least one puncturing structure 418 will be located in a position proximate to the lid and container wall. The container opener 400 may then be rotated about the center of the container to separate the lid from the container wall by cutting the seal. After the container opener 400 has been rotated a substantial amount (approx. 270° or more), any remaining seal that is still affixed may be torn apart to fully release the lid from the container wall. A user may then have full access to the inside of the container and any contents thereof.

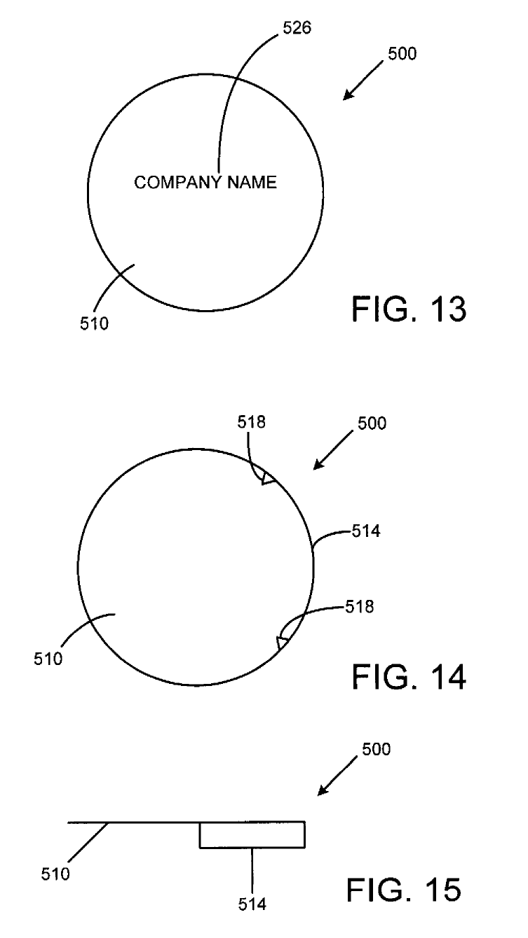

FIGS. 13, 14 and 15 are top-view, bottom-view and side-view illustrations, respectively, of a container opener 500 in accordance with a fifth exemplary embodiment of the present disclosure. The container opener 500 includes a handle portion 510, a container guide 514 and at least one puncturing structure 518. The handle portion 510 may include any structure, such as a planar structure having at least two substantially planar sides and a convenient ergonomic design. Additionally, the handle portion 510 may include any shape, such as a substantially circular shape, as depicted in FIGS. 13 and 14. The container guide 514 may be affixed to the handle portion 510 in a variety of configurations. In the fifth exemplary embodiment, the container guide 514 is affixed to one of the planar sides and protrudes away from the planar surface of the handle portion 510. The container guide 514 may include any shape, such as a curved or arced shape that is located along a portion of the circumference of the handle portion 510, as depicted in FIG. 14. The at least one puncturing structure 518 may be affixed to one or more sides of the container guide 514.

The container opener 500 also may include an attachment hole (not shown) for attaching a key ring or other structure to the container opener 500, and/or an identifying mark 526 to identify a characteristic or origin of the container opener 500. The identifying mark 526 may include any means of identifying the container opener 500, including an inscribed, printed, embedded or otherwise affixed word, logo, design, texture or picture. In FIG. 13, the identifying mark 526 is located on a planar surface of the container opener 500, but it may be located on any other part of the container opener 500 as well.

The container opener 500, and any combination of the parts thereof, may be constructed from a variety of materials, including plastics, metals ceramics and composite or organic materials. For example, the container opener 500 may include a handle portion 510 and container guide 514 that are constructed from extruded plastic and an at least one puncturing structure 518 constructed from a metallic composition. Additionally, the container opener 500 may be constructed with a variety of adhesives materials or manufacturing techniques, all of which are considered within the scope of the present disclosure. The container opener 500 may also include other materials, such as paint or reflective coatings, or other devices, such as small LED lights or bottle openers.

The container opener 500 may be used with a variety of containers, having a variety of shapes and sizes. In accordance with the fifth exemplary embodiment, the container may be cylindrical in shape and have a lid that is affixed to one of the two opposing ends of the container. The lid may be affixed to the container wall with a puncturable seal, such as adhesive paper or tape. In use, the container opener 500 may be placed proximate to the container, such that the handle portion 510 abuts the lid of the container, and the container guide 514 abuts a portion of the cylindrical wall of the container. The container opener 500 may be biased towards the center of the container to a position where the at least one puncturing structure 518 punctures a seal. As the seal is punctured, the at least one puncturing structure 518 will be located in a position proximate to the lid and container wall. The container opener 500 may then be rotated about the center of the container to separate the lid from the container wall by cutting the seal. After the container opener 500 has been rotated a substantial amount (approx. 270° or more), any remaining seal that is still affixed may be torn apart to fully release the lid from the container wall. A user may then have full access to the inside of the container and any contents thereof.

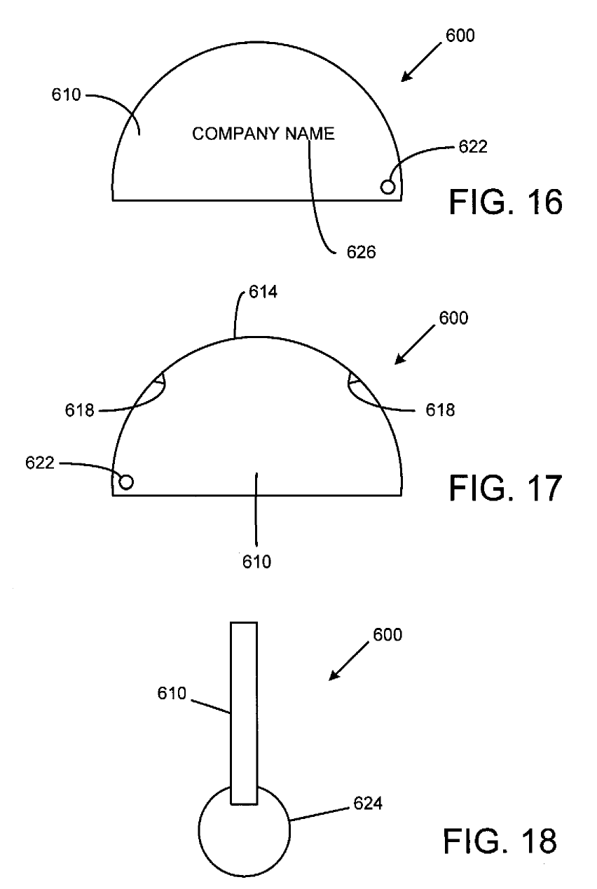

FIGS. 16, 17 and 18 are top-view, bottom-view and side-view illustrations, respectively, of a container opener 600 in accordance with a sixth exemplary embodiment of the present disclosure. The container opener 600 includes a handle portion 610, a container guide 614 and at least one puncturing structure 618. The handle portion 610 may include any structure, such as a planar structure having at least two substantially planar sides and a convenient ergonomic design. Additionally, the handle portion 610 may include any shape, such as a semi-circular shape, as depicted in FIGS. 16 and 17. The container guide 614 may be affixed to the handle portion 610 in a variety of configurations. In the sixth exemplary embodiment, the container guide 614 is affixed to one of the planar sides and protrudes away from the planar surface of the handle portion 610. The container guide 614 may include any shape, such as a curved or arced shape that is located along a portion of the circumference of the handle portion 610, as depicted in FIG. 17. The at least one puncturing structure 618 may be affixed to one or more sides of the container guide 614.

The container opener 600 also may include an attachment hole 622 for attaching a key ring 624 or other structure to the container opener 600, and/or an identifying mark 626 to identify a characteristic or origin of the container opener 600. The identifying mark 626 may include any means of identifying the container opener 600, including an inscribed, printed, embedded or otherwise affixed word, logo, design, texture or picture. In FIG. 16, the identifying mark 626 is located on a planar surface of the container opener 600, but it may be located on any other part of the container opener 600 as well.

The container opener 600, and any combination of the parts thereof, may be constructed from a variety of materials, including plastics, metals ceramics and composite or organic materials. For example, the container opener 600 may include a handle portion 610 and container guide 614 that are constructed from extruded plastic and an at least one puncturing structure 618 constructed from a metallic composition. Additionally, the container opener 600 may be constructed with a variety of adhesives materials or manufacturing techniques, all of which are considered within the scope of the present disclosure. The container opener 600 may also include other materials, such as paint or reflective coatings, or other devices, such as small LED lights or bottle openers.

The container opener 600 may be used with a variety of containers, having a variety of shapes and sizes. In accordance with the sixth exemplary embodiment, the container may be cylindrical in shape and have a lid that is affixed to one of the two opposing ends of the container. The lid may be affixed to the container wall with a puncturable seal, such as adhesive paper or tape. In use, the container opener 600 may be placed proximate to the container, such that the handle portion 610 abuts the lid of the container, and the container guide 614 abuts a portion of the cylindrical wall of the container. The container opener 600 may be biased towards the center of the container to a position where the at least one puncturing structure 618 punctures a seal. As the seal is punctured, the at least one puncturing structure 618 will be located in a position proximate to the lid and container wall. The container opener 600 may then be rotated about the center of the container to separate the lid from the container wall by cutting the seal. After the container opener 600 has been rotated a substantial amount (approx. 270° or more), any remaining seal that is still affixed may be torn apart to fully release the lid from the container wall. A user may then have full access to the inside of the container and any contents thereof.

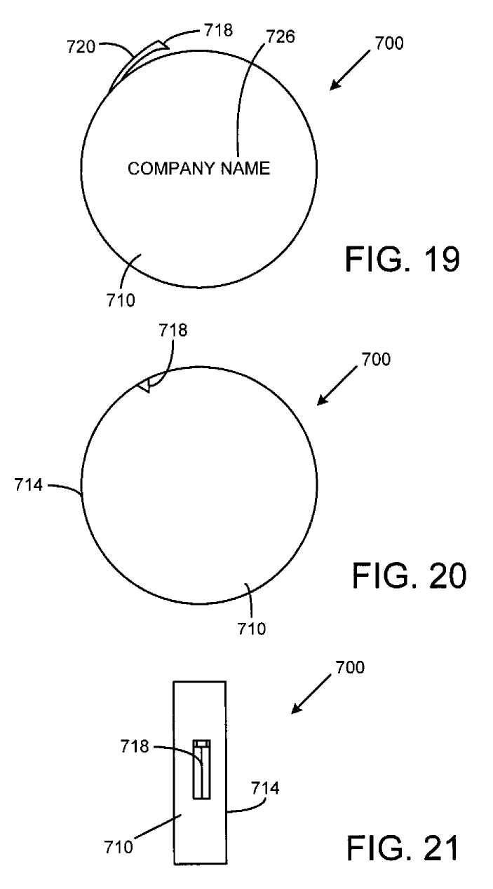

FIGS. 19, 20 and 21 are top-view, bottom-view and side-view illustrations, respectively, of a container opener 700 in accordance with a seventh exemplary embodiment of the present disclosure. The container opener 700 includes a handle portion 710, a container guide 714 and at least one puncturing structure 718. The handle portion 710 may include any structure, such as a planar structure having at least two substantially planar sides and a convenient ergonomic design. Additionally, the handle portion 710 may include any shape, such as a substantially circular shape, as depicted in FIGS. 19 and 20. The container guide 714 may be affixed to the handle portion 710 in a variety of configurations. In the seventh exemplary embodiment, the container guide 714 is affixed to one of the planar sides and protrudes away from the planar surface of the handle portion 710. The container guide 714 may include any shape, such as a curved or arced shape that is located along the entire circumference of the handle portion 710, as depicted in FIG. 20. The at least one puncturing structure 718 may be affixed to one or more sides of the container guide 714. In the seventh exemplary embodiment, the at least one puncturing structure 718 is affixed with a depressible structure 720, capable of being depressed towards an interior portion of the container opener 700.

The container opener 700 also may include an attachment hole (not shown) for attaching a key ring or other structure to the container opener 700, and/or an identifying mark 726 to identify a characteristic or origin of the container opener 700. The identifying mark 726 may include any means of identifying the container opener 700, including an inscribed, printed, embedded or otherwise affixed word, logo, design, texture or picture. In FIG. 19, the identifying mark 726 is located on a planar surface of the container opener 700, but it may be located on any other part of the container opener 700 as well.

The container opener 700, and any combination of the parts thereof, may be constructed from a variety of materials, including plastics, metals ceramics and composite or organic materials. For example, the container opener 700 may include a handle portion 710, container guide 714 and depressible structure 720 that are constructed from extruded plastic and an at least one puncturing structure 718 constructed from a metallic composition. Additionally, the container opener 700 may be constructed with a variety of adhesives materials or manufacturing techniques, all of which are considered within the scope of the present disclosure. The container opener 700 may also include other materials, such as paint or reflective coatings, or other devices, such as small LED lights or bottle openers.

The container opener 700 may be used with a variety of containers, having a variety of shapes and sizes. In accordance with the seventh exemplary embodiment, the container may be cylindrical in shape and have a lid that is affixed to one of the two opposing ends of the container. The lid may be affixed to the container wall with a puncturable seal, such as adhesive paper or tape. In use, the container opener 700 may be placed proximate to the container, such that the handle portion 710 abuts the lid of the container, and the container guide 714 abuts the entire circumference of the cylindrical wall of the container. In this position, the depressible structure 720 may be depressed towards the center of the container to a position where the at least one puncturing structure 718 punctures a seal. As the seal is punctured, the at least one puncturing structure 718 will be located in a position proximate to the lid and container wall. The container opener 700 may then be rotated about the center of the container to separate the lid from the container wall by cutting the seal. After the container opener 700 has been rotated a substantial amount (approx. 270° or more), any remaining seal that is still affixed may be torn apart to fully release the lid from the container wall. A user may then have full access to the inside of the container and any contents thereof.

It should be emphasized that the above-described embodiments of the present disclosure, particularly, any “preferred” embodiments, are merely possible examples of implementations merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A container opener comprising:
a handle portion;
a container guide affixed to the handle portion; and
at least one puncturing structure affixed to the container guide.

2. The container opener of claim 1, wherein the handle portion is substantially planar structure having at least two planar sides, wherein the container guide is affixed to one of the at least two planar sides and protrudes away from the one of the at least two planar sides.

3. The container opener of claim 1, wherein the container guide is arced shaped.

4. The container opener of claim 1, further comprising an identifying mark located on at least one of the handle portion and the container guide, the identifying mark identifying a characteristic of the container opener.

5. The container opener of claim 1, further comprising an attachment hole within the handle portion.

6. The container opener of claim 1, further comprising a plurality of container guides affixed to the handle portion.

7. The container opener of claim 1, further comprising an angled guiding surface within the container guide.

8. The container opener of claim 1, further comprising at least one ergonomic cutout portion within the handle portion.

9. The container opener of claim 1, wherein the at least one puncturing structure affixed to a depressible structure within the container guide, positioned to be depressed towards an interior portion of the container opener.

10. An opening apparatus for opening a container, the opening apparatus comprising:
a handle portion, situated to revolve about a container having a circular cross-section;
a container guide affixed to the handle portion, wherein the container guide is shaped to abut at least a portion of the circumference of the container; and
at least two puncturing structures affixed to the container guide, situated to puncture a seal affixed to a wall of the container, and bisect the seal as the handle portion is revolved relative to the container.
